(19) United States
(12) Patent Application Publication
(10) Pub. No.: US 2011/0106818 A1
(43) Pub. Date: May 5, 2011

(54) METHODS AND SYSTEMS FOR SOLVING TASKS

(75) Inventors: Li Zhang, Clifton Park, NY (US); Patricia Denise Mackenzie, Clifton Park, NY (US); Joseph James Salvo, Schenectady, NY (US); John William Carbone, Ballston Spa, NY (US); Charles Burton Theurer, Alplaus, NY (US)

(73) Assignee: GENERAL ELECTRIC COMPANY, SCHENECTADY, NY (US)

(21) Appl. No.: 12/608,045

(22) Filed: Oct. 29, 2009

(51) Int. Cl. G06F 17/30; G06F 15/173

(52) U.S. Cl. 707/749; 709/224; 707/E17.014; 707/E17.032

(57) ABSTRACT

A system for determining a solution is presented. The system includes a plurality of nodes operationally associated with one another via a network. The plurality of nodes include a data repository configured to store information and experiences of a corresponding node, a processing subsystem operationally coupled to the data repository, and configured to generate a target query, receive a target query from one or more nodes of the plurality of nodes, or both, select one or more target query relevant nodes from the plurality of nodes based on the target query, extract target query relevant information and target query relevant experiences from a corresponding data repository, exchange the target query relevant information and the target query relevant experiences with the one or more target query relevant nodes; and collectively determine a solution to the target query based upon the exchanged target query relevant information and the target query relevant experiences.

### BACKGROUND

The invention relates generally to a field of information sharing, and more particularly to methods and systems for collectively solving problems by sharing information.

Collective intelligence is a form of intelligence that emerges from a collaboration of many components or devices that have unsophisticated intelligence and follow simple, but rigorous rules. Typically, currently available conventional collective intelligent systems (CIS) have a top-down structure. These conventional collective intelligent systems, for example, may have a plurality of components or devices connected to a centralized decision making authority or a central management subsystem. The centralized decision making authority or the central management subsystem make decisions in response to queries from the plurality of devices in the conventional collective intelligent systems. In other words, decisions are pushed from the centralized decision making authority or the central management subsystem to the components or devices. Thus, in a typical conventional collective intelligent system, all the components or devices are dependent upon a centralized decision making authority or a central management subsystem for decisions, leading to increase in number of communications between the various components of the collective intelligent system and bandwidth requirement. The increased number of communications thereby leads to large network loads, delays in decisions, an increase in workload on the centralized decision making authority or the central management subsystem, and an increase in resource requirement.

Accordingly, it is highly desirable to develop collective intelligent systems and methods that circumvent the shortcomings of the currently available collective intelligent systems. More particularly, it is desirable to develop collective intelligent systems that are independent of a top-down structure. Moreover, there is a need for improved collective intelligent systems and methods that require less bandwidth, and have a reduced cost of communication. Furthermore, there is a need for collective intelligent systems and methods that reduce network loads and are capable of making faster and efficient decisions. Also, robust collective intelligent systems and methods are required that reduce network failures, are self-organizing and adapt easily to the changing environments.

### BRIEF DESCRIPTION

Briefly in accordance with one aspect of the technique, a system for determining a solution is presented. The system includes a plurality of nodes operationally associated with one another. Each of the plurality of nodes includes a processing subsystem operationally coupled to the data repository, and configured to generate a target query, receive a target query from one or more nodes in the plurality of nodes, or both, select one or more target query relevant nodes from the plurality of nodes based upon the target query, extract target query relevant information and target query relevant experiences from a corresponding data repository, exchange the target query relevant information and the target query relevant experiences with the one or more target query relevant nodes, and collectively determine a solution to the target query based upon the exchanged target query relevant information and the target query relevant experiences.

In accordance with still another embodiment of the present technique, a method for determining a solution is presented. The method includes generating a target query by a node in a plurality of nodes, receiving a target query from one or more nodes in the plurality of nodes, or both, selecting one or more target query relevant nodes from the plurality of nodes based upon the target query, extracting target query relevant information and target query relevant experiences from a corresponding data repository, exchanging the target query relevant information and the target query relevant experiences with the one or more target query relevant nodes, and collectively determining a solution corresponding to the target query based upon the exchanged target query relevant information and the target query relevant experiences.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical illustration of an exemplary system for determining a solution corresponding to a target query, in accordance with aspects of the present technique;

FIG. 2 is a diagrammatical illustration of a node for use in the exemplary system of FIG. 1, in accordance with aspects of the present technique;

FIG. 3 is a flow chart for determining a solution corresponding to a target query, in accordance with aspects of the present technique; and

FIG. 4 is a flow chart illustrating an exemplary method for receiving target query relevant information and target query relevant experiences, in accordance with aspects of the present technique.

### DETAILED DESCRIPTION

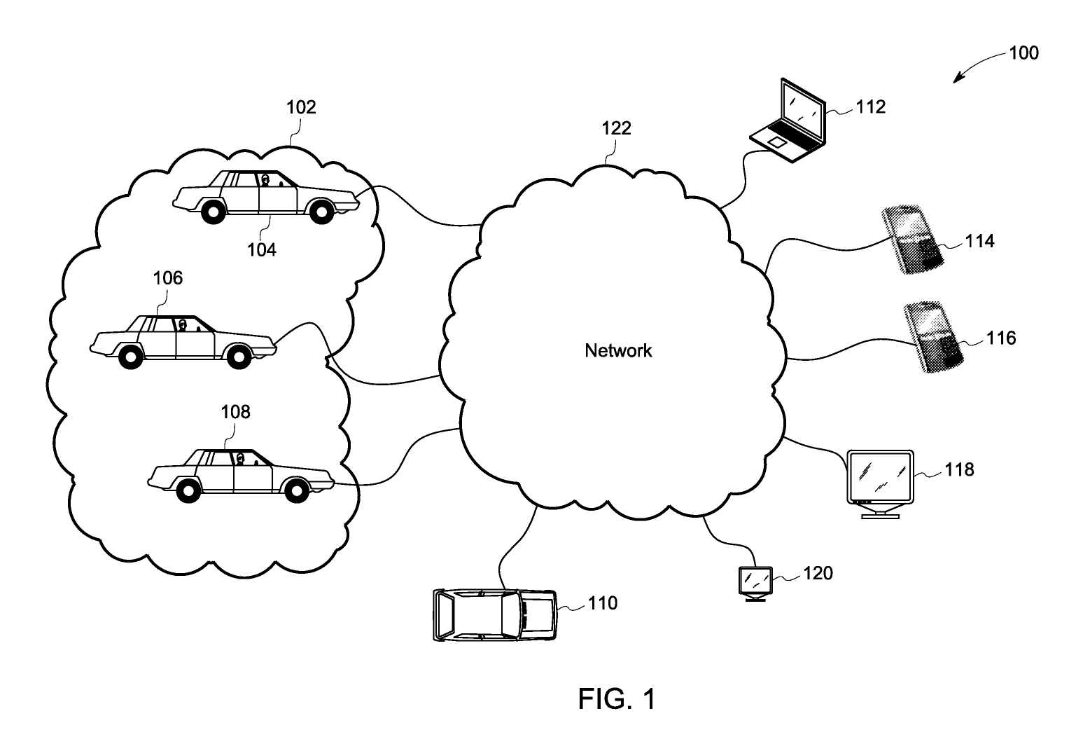

Referring to FIG. 1, a diagrammatical illustration of an exemplary system 100 for determining a solution corresponding to a target query, is depicted. The term “target query” may be used to refer to a problem, a task or a question. By way of a non-limiting example, the target query may include a direction related query, a distance related query, an estimated travel time period related query, a stocks related query, operating conditions related query, load conditions related query, configuration management related query, maintenance management related target query, and the like. More particularly, the target query may be related to nearby locations to rest, nearby locations to eat, nearby locations providing entertainment, shortest or fastest route to a destination from a current location, making a reservation in a hotel A for a particular time period, determining traffic on a particular route, estimating travel time for reaching a location A from a location B, and the like.

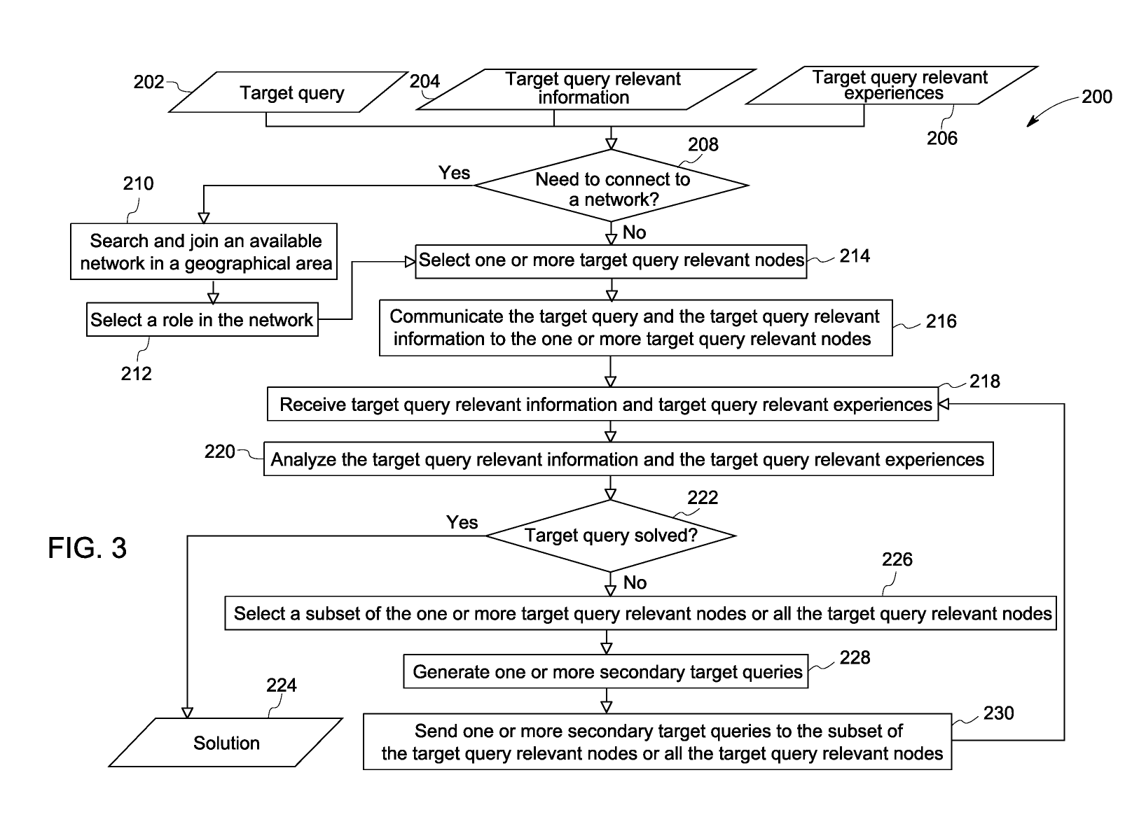

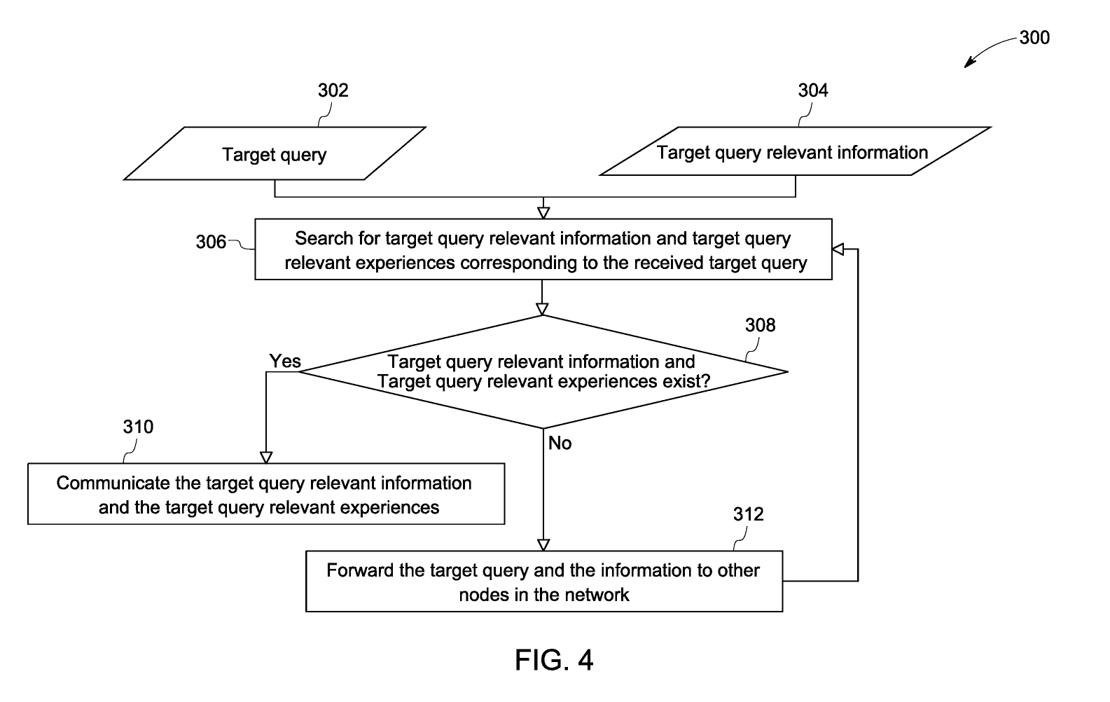

Furthermore, in one embodiment, the system 100 may include a plurality of nodes that are coupled to one another via one or more networks. As shown in the presently contemplated configuration, the plurality of nodes may include cars 104, 106, 108, 110, a laptop 112, a mobile phone 114, a personal digital assistant (PDA) 116 and desktops 118, 120. In an embodiment, the plurality of nodes 104, 106, 108, 110, 112, 114, 116, 118, 120 may be configured to select one or more target query relevant nodes from the plurality of nodes 104, 106, 108, 110, 112, 114, 116, 118, 120. As used herein, the term “one or more target query relevant nodes” may be used to refer to one or more nodes in the plurality of nodes that may have information and/or experiences related to the target query. More particularly, the term “one or more target query relevant nodes” may be used to refer to one or more nodes in the plurality of nodes that may have target query relevant information and/or target query relevant experiences. The one or more target query relevant nodes, for example, may include peer nodes, friend nodes, nodes expected to have a solution or one or more target query relevant experiences related to the target query, or combinations thereof. The friend nodes, for example, may include maintenance vehicles, crew's cell phone, a friend's vehicle, and the like. Similarly, the nodes expected to know a solution or one or more target query relevant experiences related to the target query may include a road sign transponder, maintenance vehicles, a back office system, an asset control system, a work order management system, and the like. The selection of the one or more target query relevant nodes from the plurality of nodes 104, 106, 108, 110, 112, 114, 116, 118, 120 will be described in greater detail with reference to FIGS. 3-4.

Also, as used herein, the term “target query relevant information” may be used to refer to details and/or features of one or more nodes in the target query relevant nodes that may be relevant to the determination of a solution corresponding to the target query. Further, as used herein, the term “target query relevant experiences” may be used to refer to past experiences of one or more nodes in the target query relevant nodes that may be relevant to the determination of the solution corresponding to the target query.

Additionally, in one embodiment, the plurality of nodes and/or one or more target query relevant nodes may be configured to exchange target query relevant information and target query relevant experiences with one another. Also, the plurality of nodes 104, 106, 108, 110, 112, 114, 116, 118, 120 and/or one or more target query relevant nodes may be configured to collectively determine a solution corresponding to the target query based upon the exchanged target query relevant information and the exchanged target query relevant experiences. The collective determination of the solution corresponding to the target query based upon the exchanged target query relevant information and the exchanged target query relevant experiences will be described in greater detail with reference to FIGS. 3-4. In one embodiment, a node 1 in the plurality of nodes may exchange target query relevant information and target query relevant experiences with a node 2 in the plurality of nodes to collectively determine a solution corresponding to a target query Q1 corresponding to the node 1. Also, the node 2 may further exchange target query relevant information and target query relevant experiences with other nodes in the plurality of nodes to determine a solution corresponding to the target query Q1. Further, nodes 3, 4 and 5 in the plurality of nodes may also exchange target query relevant information and the target query relevant experiences to determine a solution corresponding to the target query Q1. In still another embodiment, the nodes 3, 4 and 5 in the plurality of nodes may exchange target query relevant information and target query relevant experiences to determine solutions corresponding to target queries corresponding to the nodes 3, 4 and 5.

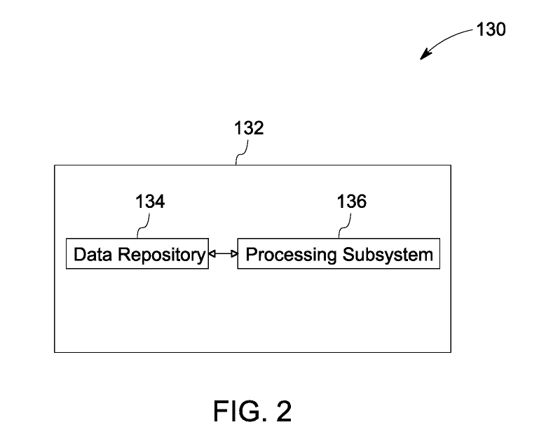

Further, in accordance with exemplary aspects of the present technique, one or more nodes in the plurality of nodes 104, 106, 108, 110, 112, 114, 116, 118, 120 may include a corresponding data repository and a corresponding processing subsystem. Referring now to FIG. 2, a diagrammatical illustration 130 of a node 132 for use in the system 100 of FIG. 1, in accordance with aspects of the present technique, is depicted. More particularly, FIG. 2 illustrates the node 132 that may be one or more nodes in the plurality of nodes 104, 106, 108, 110, 112, 114, 116, 118, 120 (see FIG. 1). Further, in accordance with exemplary aspects of the present technique, the node 132 may be configured to determine a solution corresponding to a target query. More particularly, the node 132 in conjunction with one or more target query relevant nodes may be configured to collectively determine a solution corresponding to the target query by exchanging corresponding target query relevant information and target query relevant experiences with one another.

Additionally, in certain embodiments the node 132 may include a telematics device, a non-telematics device, or a device affixed to a telematics device. Furthermore, in certain other embodiments, the node 132 may include a telematics device affixed to an automobile, a mobile phone, a personal digital assistant, a laptop, a road sign transponder, or the like. Similarly, the node 132 may also include a desktop or a device having limited mobile capability.

In accordance with exemplary aspects of the present technique, the node 132 may include a data repository 134 operationally coupled to a processing subsystem 136. In one embodiment, the data repository 134 may be configured to store information and experiences of the node 132. As used herein, the term “information” may be used to refer to details and/or features associated with the node 132. By way of example, if the node 132 is an automobile, then the information may include details and/or features of the automobile, such as hardware specifications, resources available, bandwidth, range, travel time period, speed, direction, destination, traffic information, idling time period, and the like. Further, as used herein, the term “experiences” may be used to refer to past actions and/or past reactions of the node 132 in response to one or more past target queries for which optimized solutions have been previously determined. By way of example, if the node 132 is an automobile, then the experiences may include nearest locations for resting and/or eating, traffic from point A to point B, nearest gas station from a point A, and the like.

Furthermore, in one embodiment, the processing subsystem 136 in the node 132 may be configured to generate the target query. Alternatively, the processing subsystem 136 may be configured to receive the target query from one or more nodes in the plurality of nodes 104, 106, 108, 110, 112, 114, 116, 118, 120. Additionally, the processing subsystem 136 may be configured to select one or more target query relevant nodes from the plurality of nodes 104, 106, 108, 110, 112, 114, 116, 118, 120 based upon the target query. The processing subsystem 136 may be further configured to extract target query relevant information from the information corresponding to the node 132, and extract target query relevant experiences from the experiences corresponding to the node 132. As previously noted, the information and experiences may be stored in the data repository 134. In certain embodiments, the processing subsystem 136 may also be configured to extract target query relevant information and target query relevant experiences from the Internet to determine a solution to the target query. In still other embodiments, the processing subsystem 136 may also be configured to exchange the target query relevant information and the target query relevant experiences with other target query relevant nodes. More particularly, the processing subsystem 136 may be configured to communicate the target query relevant information and the target query relevant experiences extracted from the data repository 134 and/or the Internet to the other target query relevant nodes and receive target query relevant information and target query relevant experiences from processing subsystems corresponding to the other nodes. The extraction of target query relevant information and target query relevant experiences will be described in greater details with reference to FIGS. 3-4. Similarly, the exchange of the target query relevant information and the target query relevant experiences with the other target query relevant nodes will also be described in greater detail with reference to FIGS. 3-4.

According to exemplary aspects of the present technique, the exchange of the target query relevant information and the target query relevant experiences may be followed by a collective determination of a solution corresponding to the target query. More particularly, the collective determination of the corresponding solution may be based upon the exchanged target query relevant information and the exchanged target query relevant experiences. The collective determination of the solution corresponding to the target query will be explained in greater detail with reference to FIGS. 3-4.

With returning reference to FIG. 1, as previously noted with reference to FIG. 2, the plurality of nodes 104, 106, 108, 110, 112, 114, 116, 118, 120 may include respective processing subsystems and data repositories. More particularly, in one embodiment, each of the plurality of nodes 104, 106, 108, 110, 112, 114, 116, 118, 120 may include a respective processing subsystem, such as the processing subsystem 136 (see FIG. 2) and a respective data repository, such as the data repository 134 (see FIG. 2). In certain embodiments, the data repositories of the plurality of nodes 104, 106, 108, 110, 112, 114, 116, 118, 120 may be configured to store their corresponding information and experiences. Furthermore, the processing subsystems of the plurality of nodes 104, 106, 108, 110, 112, 114, 116, 118, 120 may be configured to collectively determine the solution corresponding to the target query based upon the exchanged target query relevant information and the exchanged target query relevant experiences. The collective determination of the solution by the plurality of nodes 104, 106, 108, 110, 112, 114, 116, 118, 120 may lead to fast decentralized determination of an optimized solution corresponding to the target query, thereby leading to a reduced number of network failures.

Moreover, the plurality of nodes 104, 106, 108, 110, 112, 114, 116, 118, 120 may include peer devices or non-peer devices. As used herein, the term “peer devices” may be used to refer to telematics devices, devices having mobile capability, devices that are affixed to telematics devices, or combinations thereof. Further, as used herein, the term “non-peer devices” may be used to refer to devices having limited or no mobile capability, and devices that are not affixed to non-telematics devices. In an exemplary embodiment, the peer devices may include a telematics device affixed to a mobile phone, a personal digital assistant, a laptop, an automobile, electronic devices having mobile capability and the like. Similarly, the non-peer devices may include a computer, a server, a desktop, other non-telematics devices, a road sign transponder, or other similar computing devices. As illustrated in the presently contemplated configuration of FIG. 1, the peer devices may include the cars 104, 106, 108, 110, the laptop 112, the mobile phone 114 and the personal digital assistant (PDA) 116, each of which peer devices are affixed to telematics devices. Further, the non-peer devices may include the desktops 118, 120.

Moreover, the plurality of nodes 104, 106, 108, 110, 112, 114, 116, 118, 120 may be operationally coupled with one another via a network 122. Also, the network 122 may include a satellite network, a local area network, a wide area network, a private network, a wired network, a wireless network, and the like. In certain embodiments, the network 122 may include a plurality of sub-networks. By way of example, as illustrated in the presently contemplated configuration, the cars 104, 106, 108 may also be coupled with one another via a private network 102. It should be noted that while in the presently contemplated configuration, the private network 102 includes only the peer devices, such as the cars 104, 106, 108, in certain other embodiments, the private network 102 may also include non-peer devices. Further, in certain embodiments, the plurality of nodes 104, 106, 108, 110, 112, 114, 116, 118, 120 may communicate with one another using one or more communication modes, such as, but not limited to, Global System for Mobile Communications method (GSM), Internet, a General Packet Radio Service method (GPRS), Bluetooth, a Worldwide Interoperability for Microwave Access method (Wi-Max), Wi-Fi, 802.15.4 (Zigbee or similar), and the like.

As previously alluded to, in accordance with exemplary aspects of the present technique, one or more of the plurality of nodes 104, 106, 108, 110, 112, 114, 116, 118, 120 may be configured to collectively determine a solution corresponding to the target query based upon the exchanged target query relevant information and the exchanged target query relevant experiences. The collective determination of a solution corresponding to the target query will be described in greater detail with reference to FIGS. 3-4.

Turning now to FIG. 3, a flow chart 200 for determining a solution corresponding to a target query, in accordance with aspects of the present technique, is depicted. Although the present technique is described with reference to automobiles, it may be noted that the present technique may also find application in a traffic information/monitoring and prediction system, an aircraft air and ground traffic monitoring and prediction system, a stock market prediction system, a videogame, a social problem solving system, a prognostics and health maintenance system, and the like. As illustrated in FIG. 3, reference numeral 202 may be representative of a target query, while reference numeral 204 may be representative of target query relevant information. As previously noted with reference to FIG. 1 and FIG. 2, a node in the plurality of nodes 104, 106, 108, 110, 112, 114, 116, 118, 120 may be configured to generate a target query. Alternatively, a node in the plurality of nodes 104, 106, 108, 110, 112, 114, 116, 118, 120 may receive a target query from other node in the plurality of nodes 104, 106, 108, 110, 112, 114, 116, 118, 120. As previously noted, the term “target query relevant information” is used to refer to details and/or features of the one or more target query relevant nodes that may contribute significantly to the determination of the solution corresponding to the target query. In one embodiment, the target query relevant information 204 may include details and/or features of a node, such as hardware configuration, type of node, name of node, a location, a destination, a range of the plurality of nodes, geographical area, and the like. By way of example, a node n₁, such as an automobile may generate a target query q₁, such as, “How far is the nearest gas station from my current location?” Similarly the target query relevant information corresponding to the node n₁, for example, may include a name of the node, a domain of the node, type of node, a location, an exact location, working condition, speed, a destination, gas remaining in the tank, number of kilometers that can be traveled with the remaining gas, and the like. In one embodiment, the node n₁ may include the node 132 (see FIG. 2). Accordingly, the node n₁ may include a corresponding data repository, such as the data repository 134 (see FIG. 2) and a processing subsystem, such as the processing subsystem 136 (see FIG. 2). In certain embodiments, the target query relevant information 204 corresponding to the node n₁ may be stored in the data repository of the node n₁. Furthermore, the target query 202, for example, may be generated by the processing subsystem 136 (see FIG. 2) of a node, such as the node n₁.

Moreover, as depicted in FIG. 3, reference numeral 206 may be representative of target query relevant experiences corresponding to the node n₁. The target query relevant experiences 206, for example, may include a shortest or an optimized path from a location A to another location B, nearest gas station from the location A, and the like. In one embodiment, the target query relevant experiences 206 may be stored in the data repository of the node n₁, such as the data repository 134. As previously noted with reference to FIGS. 1-2, the target query relevant experiences 206 of the node n₁ may be generated after one or more actions or reactions of the node n₁ that resulted in generation of one or more optimized solutions corresponding to one or more target queries.

The method starts at step 208, where a check may be carried out to verify if the node n₁ is currently associated with a network. The network, for example, may include the networks 102, 122 (see FIG. 1). Accordingly, in one embodiment, at step 208, a check may be carried out to verify if the node n₁ is already connected to one or more networks, and/or is in communication with a plurality of nodes in the network. Consequent to the processing of step 208, if it is verified that it is desirable for the node n₁ to join a network, then control may be transferred to step 210. At step 210, the node n₁ may search for an available network in a determined geographical area, and may subsequently join the network. The network, for example, may be searched by broadcasting a message in the desired geographical area. In certain embodiments, the node n₁ may search for a network by sending a message to a peer device for determining details of available networks.

Subsequent to step 210, the node n₁ may identify a role for itself relative to other nodes in the network, as indicated by step 212. For, example, the node n₁ may identify its role as a target query generator, a target query solver, or both. As used herein, the term “target query generator” may be used to refer to a node that has a capability or resources to generate target queries. Similarly, as used herein, the term “target query solver” may be used to refer to a node that has desired available resources to participate in a collective determination of a solution corresponding to a target query. In one embodiment, the node n₁, may identify its role by sharing information, such as, idle time period of the node n₁, approximate number of resources required for collectively solving a target query, approximate time period required for solving a target query, and the like with other nodes. Further to the determination of the role by the node n₁ at step 212, control may be transferred to step 214. Referring again to step 208, if it is verified that the node n₁ is already a part of one or more networks, or the node n₁ does not need to be associated with any network, then control may be transferred to the step 214.

Moreover, at step 214, the node n₁ may select one or more target query relevant nodes from a plurality of nodes in the network. More particularly, the processing subsystem of the node n₁ may select the one or more target query relevant nodes from the plurality of nodes in the network. The one or more target query relevant nodes, for example, may include nodes in the network that may contribute significantly to the determination of a solution corresponding to the target query 202. In one embodiment, the node n₁ may select the one or more target query relevant nodes by broadcasting its target query relevant information 204 to the plurality of nodes in the network, and receiving target query relevant information from the plurality of nodes. In such an embodiment, the node n₁ may select the one or more target query relevant nodes that have target query relevant information substantially similar to its target query relevant information 204. For example, the node n₁ may select “cars” as the one or more target query relevant nodes as opposed to “trucks.” Similarly, the node n₁ may select the one or more target query relevant nodes that are traveling towards a desired region in the geographical area. It may be noted that in accordance with aspects of the present technique, in certain embodiments, the step of selecting the one or more target query relevant nodes may be an optional step.

Moreover, consequent to the determination of the one or more target query relevant nodes, the node n₁ may communicate the target query 202, the target query relevant information 204 and/or the target query relevant experiences 206 to the one or more target query relevant nodes, as indicated by step 216. It may be noted that if one or more target query relevant nodes are not selected at step 214, then the node n₁ may broadcast the target query 202, the target query relevant information 204 and/or the target query relevant experiences 206 to all nodes in the network.

Furthermore, at step 218, target query relevant information and target query relevant experiences corresponding to one or more of the target query relevant nodes may be received by the node n₁ in response to the target query 202, the target query relevant information 204 and/or the target query relevant experiences 206 sent by the node n₁. The receipt of the target query relevant information and the target query relevant experiences by the node n₁ may be better understood with reference to FIG. 4.

Referring now to FIG. 4, a flow chart 300 illustrating an exemplary method for receiving target query relevant information and target query relevant experiences, in accordance with aspects of the present technique, is depicted. In other words, the processing of step 218 of FIG. 3 is presented in greater detail in FIG. 4. Reference numeral 302 may be representative of a target query received by one or more target query relevant nodes, and reference numeral 304 may be representative of target query relevant information received by the one or more target query relevant nodes. In one embodiment, the received target query 302 may include the target query 202 (see FIG. 3), and the received target query relevant information 304 may include the target query relevant information 204 (see FIG. 3).

Further, the method starts at step 306, where the one or more target query relevant nodes search for corresponding target query relevant information and the target query relevant experiences in their corresponding data repositories. More particularly, processing subsystems corresponding to the one or more target query relevant nodes may search for corresponding target query relevant information and target query relevant experiences in their corresponding data repositories. By way of example, if the received target query 302 is, “Is there a gas station that is reachable with the amount of gas in my gas tank?,” then the one or more target query relevant nodes may search their corresponding data repositories for target query relevant information and target query relevant experiences that may be relevant and may substantially contribute to the determination of a solution corresponding to the received target query 302. The target query relevant information searched for by the one or more target query relevant nodes may include hardware configuration, location, specific location, oil tank capacity, inventory, and the like. Similarly, the target query relevant experiences searched for by the target query relevant nodes may include a past location, a past location of a gas station, a past distance of the gas station from the past location, and the like.

Subsequently, at step 308, a check may be carried out by the one or more target query relevant nodes to verify existence of target query relevant information and target query relevant experiences in their corresponding data repositories. At step 308, if it is verified that target query relevant information and target query relevant experiences exist in the corresponding data repositories of the one or more target query relevant nodes, then control may be transferred to step 310. At step 310, the one or more target query relevant nodes may transmit their corresponding target query relevant information and the target query relevant experiences to the node n₁.

However, at step 308, if it is determined that the target query relevant nodes failed to find any relevant target query relevant information and target query relevant experiences, then control may be transferred to step 312. Specifically, the one or more target query relevant nodes may forward the received target query 302 and the received target query relevant information 304 to other nodes in the network, as indicated by step 312. The other nodes, for example, may include nodes in the network that may have information substantially similar to the received target query relevant information 304. Subsequent to step 312, control may be transferred to step 306, where the other new nodes may search their data repositories for corresponding target query relevant information and the target query relevant experiences. Further, the other nodes may transmit any corresponding target query relevant information and the target query relevant experiences to the node n₁ via processing of steps 306-312.

With returning reference to FIG. 3, at step 220, the node n₁ may analyze the target query relevant information and the target query relevant experiences received from the one or more target query relevant nodes. More particularly, the node n₁ may analyze the target query relevant information and the target query relevant experiences received from one or more target query relevant nodes to determine a solution corresponding to the target query 202. By way of example, if the node n₁ receives at least a desired number of similar target query relevant experiences having atleast desired similarities in the corresponding target query relevant information, then the node n₁ may determine a solution substantially similar to the actions, reactions, or solutions disclosed in a majority of similar target query relevant experiences. For example, if the target query relevant experiences received from a majority of the one or more target query relevant nodes including a target query relevant information as “small cars” suggest a route A→B to reach a nearest gas station from the present location of the node n₁, then the node n₁ may determine a solution to the target query 202 to include the route A→B to reach the nearest gas station.

It may be noted that in certain embodiments, the analysis of the target query relevant experiences and the target query relevant information may not lead to determination of a solution corresponding to the target query 202. In one embodiment, the solution corresponding to the target query 202 may not be determined due to ambiguous and/or contrary target query relevant experiences received from the one or more target query relevant nodes.

Subsequently, at step 222, a check may be carried out to verify if a solution corresponding to the target query 202 has been determined. At step 222, if it is verified that the solution corresponding to the target query 202 has been determined, then determination of the solution corresponding to the target query 202 may be confirmed. Reference numeral 224 may be indicative of a solution corresponding to the target query 202.

Furthermore, in certain embodiments, if it is verified at step 222 that the solution corresponding to the target query 202 has not been determined, then control may be transferred to step 226. At step 226, a subset of the one or more target query relevant nodes may be selected. The subset of the one or more target query relevant nodes may be selected by using a method similar to the method described with reference to step 214 of FIG. 3. Alternatively, all the one or more target query relevant nodes may be selected, as indicated by step 226. The subset of the one or more target query relevant nodes, so determined may generate one or more secondary target queries based upon the received target query relevant information and the target query relevant experiences of the one or more target query relevant nodes, as indicated by step 228. The secondary target queries, for example, may include the target query 202, or may be a target query modified by the one or more target query relevant nodes.

Subsequently, the one or more secondary target queries may be communicated to the subset of the one or more target query relevant nodes or all the one or more target query relevant nodes, as indicated by step 230. Further to the processing of step 230, control may be transferred to step 218 where target query relevant information and target query relevant experiences may be received from the subset of the one or more target query relevant nodes or all the one or more target query relevant nodes. In one embodiment, target query relevant information and target query relevant experiences may be received from the subset of the one or more target query relevant nodes or all the one or more target query relevant using the method described with reference to FIG. 4.

The present technique provides improved collective intelligent systems and methods that require less bandwidth, and have a reduced cost of communication. Furthermore, the technique provides collective intelligent systems and methods that reduce network loads and are capable of taking faster and efficient decisions. Also, use of the technique provides robust collective intelligent systems and methods that reduce network failures, are self-organizing and easily adapt to changing environments.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for determining a solution, comprising:
a plurality of nodes operationally associated with one another, each of the plurality of nodes, comprising:
a data repository configured to store information and experiences of a corresponding node;
a processing subsystem operationally coupled to the data repository, and configured to:
generate a target query, receive a target query from one or more nodes in the plurality of nodes, or both;
select one or more target query relevant nodes from the plurality of nodes based upon the target query;
extract target query relevant information and target query relevant experiences from a corresponding data repository;
exchange the target query relevant information and the target query relevant experiences with the one or more target query relevant nodes; and
collectively determine a solution to the target query based upon the exchanged target query relevant information and the target query relevant experiences.

2. The system of claim 1, wherein the plurality of nodes comprises telematics devices, non-telematics devices, peer devices, non-peer devices, or combinations thereof.

3. The system of claim 1, wherein the plurality of nodes are operationally associated with one another via a network.

4. The system of claim 3, wherein the network comprises a satellite network, a local area network, a wide area network, a private network, a wired network, a wireless network, or combinations thereof.

5. The system of claim 1, wherein the plurality of nodes are configured to communicate with the one or more target query relevant nodes via a Bluetooth, a Global System for Mobile Communications (GSM), a General Packet Radio Service method (GPRS), a Worldwide Interoperability for Microwave Access method (Wi-Max), Wi-Fi, 802.15.4 (Zigbee or similar), Internet, or combinations thereof.

6. The system of claim 1, wherein the one or more target query relevant nodes comprise peer nodes, friend nodes, nodes that are expected to have a solution or an experience related to the target query, or combinations thereof.

7. The system of claim 1, wherein the one or more target query relevant nodes are located in a desired geographical area.

8. The system of claim 1, wherein the one or more target query relevant nodes are located in a determined range.

9. The system of claim 1, wherein the system further comprises a traffic information/monitoring and prediction system, an aircraft air and ground traffic monitoring and prediction system, a stock market prediction system, a videogame, a social problem solving system, a prognostics and health maintenance system, a personal companion, or combinations thereof.

10. The system of claim 1, wherein the information stored in the data repository comprises details of the corresponding node in the plurality of nodes.

11. The system of claim 1, wherein the experiences stored in the data repository comprise successful past actions or reactions of the corresponding node in response to a past target query.

12. A method for determining a solution, comprising:
generating a target query by a node in a plurality of nodes, receiving a target query from one or more nodes in the plurality of nodes, or both;
selecting one or more target query relevant nodes from the plurality of nodes based upon the target query;
extracting target query relevant information and target query relevant experiences from a corresponding data repository;
exchanging the target query relevant information and the target query relevant experiences with the one or more target query relevant nodes; and
collectively determining a solution corresponding to the target query based upon the exchanged target query relevant information and the target query relevant experiences.

13. The method of claim 12, wherein selecting the one or more target query relevant nodes further comprises communicating the target query and information corresponding to the node to the one or more target query relevant nodes.

14. The method of claim 13, wherein extracting the target query relevant information and the target query relevant experiences further comprises receiving the target query relevant information and the target query relevant experiences communicated to the node by the one or more target query relevant nodes.

15. The method of claim 12, wherein collectively determining the solution corresponding to the target query comprises:
analyzing the target query relevant information and the target query relevant experiences received from the one or more target query relevant nodes to determine existence of atleast a desired number of similar target query relevant experiences having atleast desired similarities in the corresponding target query relevant information; and
verifying determination of a solution corresponding to the target query.

16. The method of claim 15, wherein collectively determining a solution corresponding to the target query further comprises:
selecting a subset of the one or more target query relevant nodes after an unsuccessful verification of the determination of the solution corresponding to the target query;
generating one or more secondary target queries;
communicating the one or more secondary target queries to the subset of the one or more target query relevant nodes; and
receiving target query relevant information and target query relevant experiences from the subset of the one or more target query relevant nodes.

17. The method of claim 14, wherein receiving the target query relevant information and the target query relevant experiences comprises:
searching for target query relevant information and target query relevant experiences in data repositories corresponding to the one or more nodes in the plurality of nodes; and
verifying existence of the target query relevant information and target query relevant experiences in the corresponding data repositories.

18. The method of claim 17, wherein receiving the target query relevant information and the target query relevant experiences further comprises communicating the target query relevant information and the target query relevant experiences to the node after successful verification of the existence of target query relevant information and target query relevant experiences in one or more of the corresponding data repositories.

19. The method of claim 17, wherein receiving the target query relevant information and the target query relevant experiences further comprises communicating the target query and the information to other nodes in the network after unsuccessful verification of the existence of the target query relevant information and the target query relevant experiences in one or more of the corresponding data repositories.
